(19) United States
(12) Patent Application Publication
(10) Pub. No.: US 2025/0285338 A1
(43) Pub. Date: Sep. 11, 2025

(54) METADATA-BASED THUMBNAIL IMAGE GENERATION FOR PRESENTATION ON A CONTENT PLATFORM

(71) Applicant: Google LLC, Mountain View, CA (US)

(72) Inventors: Ben David Goodrich, Woodside, CA (US); Christopher Conover, San Carlos, CA (US); Gabriela Namie Kurata, Brooklyn, NY (US); Travis Neilson, Pearl City, HI (US); Joshua Austin, San Clemente, CA (US); Tameen Khan, Palo Alto, CA (US); Michael Alexander Freeman, San Francisco, CA (US)

(21) Appl. No.: 18/597,438

(22) Filed: Mar. 6, 2024

(51) Int. Cl. G06T 11/00; G06F 40/40

(52) U.S. Cl. CPC G06T 11/00; G06F 40/40; G06T 2200/24

(57) ABSTRACT

Systems and methods for metadata-based thumbnail image generation for presentation on a content platform are provided. A request initiated by a user to generate a thumbnail image to be associated with a collection of media items stored by a content platform is received. One or more metadata items characterizing one or more expressive aspects associated with the collection of media items is identified. A textual prompt describing the thumbnail image to be generated is generated using the one or more metadata items. An artificial intelligence (AI) generative model is caused to process the textual prompt. One or more outputs from the AI generative model is obtained, the one or more outputs specifying respective one or more thumbnail images.

### TECHNICAL FIELD

Aspects and implementations of the present disclosure relate to metadata-based thumbnail image generation for presentation on a content platform.

### BACKGROUND

A platform (e.g., a content platform) can transmit media items to client devices connected to the platform via a network. A media item can include an audio item or a video item, in some instances. Users can consume the transmitted media items via a user interface (UI) provided by the platform. In some instances, a user can curate a collection of media items (e.g., a playlist). On typical content platforms, the collection of media items can be presented in the UI in connection with a default thumbnail image (e.g., cover art). The user may wish to customize the thumbnail image associated with the collection of media items to reflect expressive aspects and/or stylistic features associated with the collection of media items.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes receiving, by a processing device, a request initiated by a user to generate a thumbnail image to be associated with a collection of media items stored by a content platform. The method further includes identifying one or more metadata items characterizing respective one or more expressive aspects associated with the collection of media items. The method further includes generating, using the one or more metadata items, a textual prompt describing the thumbnail image to be generated. The method further includes causing an artificial intelligence (AI) generative model to process the textual prompt. The method further includes obtaining one or more outputs from the AI generative model, the one or more outputs specifying respective one or more thumbnail images.

In some implementations, the one or more expressive aspects associated with the collection of media items comprise at least one of: a genre associated with the collection of media items, a mood associated with the collection of media items, an emotion associated with the collection of media items, a lyrics associated with the collection of media items, a rhythm associated with the collection of media items, an instrumentation associated with the collection of media items, a vocal style associated with the collection of media items, a production style associated with the collection of media items, a cultural context associated with the collection of media items, or a theme associated with the collection of media items.

In some implementations, causing the AI generative model to process the textual prompt is performed responsive to determining that the textual prompt satisfies a content appropriateness condition. In some implementations, determining whether the textual prompt satisfies the content appropriateness condition further comprises comparing the textual prompt to an allowlist of prompt terms.

In some implementations, the method further includes receiving, via a user interface (UI), an input identifying a chosen thumbnail image of the one or more thumbnail images; and associating the chosen thumbnail image with the collection of media items.

In some implementations, the method further includes providing each of the one or more thumbnail images as input to a second trained AI model; and obtaining one or more outputs of the second trained AI model, the one or more outputs of the second AI model indicating a probability of the thumbnail image comprising an inappropriate content.

In some implementations, the method further includes causing the collection of media items to be presented in a first display area of the UI; and causing the chosen thumbnail to be presented in a second display area of the UI, wherein the second display area of the UI is presented above the first display area of the UI.

An aspect of the disclosure provides a system including a memory device and a processing device communicatively coupled to the memory device. The processing device performs operations including receiving, by the processing device, a request initiated by a user to generate a thumbnail image to be associated with a collection of media items stored by a content platform. The processing device is to perform operations further including identifying one or more metadata items characterizing respective one or more expressive aspects associated with the collection of media items. The processing device is to perform operations further including generating, using the one or more metadata items, a textual prompt describing the thumbnail image to be generated. The processing device is to perform operations further including causing an artificial intelligence (AI) generative model to process the textual prompt. The processing device is to perform operations further including obtaining one or more outputs from the AI generative model, the one or more outputs specifying respective one or more thumbnail images.

In some implementations, the one or more expressive aspects associated with the collection of media items comprise at least one of: a genre associated with the collection of media items, a mood associated with the collection of media items, an emotion associated with the collection of media items, a lyrics associated with the collection of media items, a rhythm associated with the collection of media items, an instrumentation associated with the collection of media items, a vocal style associated with the collection of media items, a production style associated with the collection of media items, a cultural context associated with the collection of media items, or a theme associated with the collection of media items.

In some implementations, causing the AI generative model to process the textual prompt is performed responsive to determining that the textual prompt satisfies a content appropriateness condition. In some implementations, determining whether the textual prompt satisfies the content appropriateness condition further comprises comparing the textual prompt to an allowlist of prompt terms.

In some implementations, the processing device is to perform operations further including receiving, via a user interface (UI), an input identifying a chosen thumbnail image of the one or more thumbnail images; and associating the chosen thumbnail image with the collection of media items.

In some implementations, the processing device is to perform operations further including providing each of the one or more thumbnail images as input to a second trained AI model; and obtaining one or more outputs of the second trained AI model, the one or more outputs of the second AI model indicating a probability of the thumbnail image comprising an inappropriate content.

In some implementations, the processing device is to perform operations further including causing the collection of media items to be presented in a first display area of the UI; and causing the chosen thumbnail to be presented in a second display area of the UI, wherein the second display area of the UI is presented above the first display area of the UI.

An aspect of the disclosure provides a computer program including instructions that, when the program is executed by a processing device, cause the processing device to perform operations including receiving, by the processing device, a request initiated by a user to generate a thumbnail image to be associated with a collection of media items stored by a content platform. The processing device is to perform operations further including identifying one or more metadata items characterizing respective one or more expressive aspects associated with the collection of media items. The processing device is to perform operations further including generating, using the one or more metadata items, a textual prompt describing the thumbnail image to be generated. The processing device is to perform operations further including causing an artificial intelligence (AI) generative model to process the textual prompt. The processing device is to perform operations further including obtaining one or more outputs from the AI generative model, the one or more outputs specifying respective one or more thumbnail images.

In some implementations, the one or more expressive aspects associated with the collection of media items comprise at least one of: a genre associated with the collection of media items, a mood associated with the collection of media items, an emotion associated with the collection of media items, a lyrics associated with the collection of media items, a rhythm associated with the collection of media items, an instrumentation associated with the collection of media items, a vocal style associated with the collection of media items, a production style associated with the collection of media items, a cultural context associated with the collection of media items, or a theme associated with the collection of media items.

In some implementations, causing the AI generative model to process the textual prompt is performed responsive to determining that the textual prompt satisfies a content appropriateness condition. In some implementations, determining whether the textual prompt satisfies the content appropriateness condition further comprises comparing the textual prompt to an allowlist of prompt terms.

In some implementations, the processing device is to perform operations further including receiving, via a user interface (UI), an input identifying a chosen thumbnail image of the one or more thumbnail images; and associating the chosen thumbnail image with the collection of media items.

In some implementations, the processing device is to perform operations further including providing each of the one or more thumbnail images as input to a second trained AI model; and obtaining one or more outputs of the second trained AI model, the one or more outputs of the second AI model indicating a probability of the thumbnail image comprising an inappropriate content.

In some implementations, the processing device is to perform operations further including causing the collection of media items to be presented in a first display area of the UI; and causing the chosen thumbnail to be presented in a second display area of the UI, wherein the second display area of the UI is presented above the first display area of the UI.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 depicts a flow diagram of a method for generating customized thumbnail images for presentation on a content platform, in accordance with implementations of the present disclosure.

FIG. 3 depicts a flow diagram of another method for generating customized thumbnail images for presentation on a content platform, in accordance with implementations of the present disclosure.

FIG. 4A depicts a flow diagram of a method for training an artificial intelligence (AI) model, in accordance with implementations of the present disclosure.

FIG. 4B depicts a flow diagram of a method for training another AI model, in accordance with implementations of the present disclosure.

FIG. 4C depicts a flow diagram of a method for training another AI model, in accordance with implementations of the present disclosure.

FIG. 4D depicts a flow diagram of a method for training another AI model, in accordance with implementations of the present disclosure.

FIG. 5A is a block diagram illustrating an example user interface (UI) displaying an example collection of media items and a default thumbnail, in accordance with implementations of the present disclosure.

FIG. 5B is a block diagram illustrating another example UI displaying one or more UI elements selectable to request a customized thumbnail, in accordance with implementations of the present disclosure.

FIG. 5C is a block diagram illustrating another example UI displaying one or more UI elements selectable to request a customized thumbnail, in accordance with implementations of the present disclosure.

FIG. 5D is a block diagram illustrating another example UI displaying an example collection of media items and a customized thumbnail, in accordance with implementations of the present disclosure.

FIG. 6 is a block diagram illustrating an exemplary computer system, in accordance with implementations of the present disclosure.

### DETAILED DESCRIPTION

Aspects of the present disclosure relate to metadata-based thumbnail image generation for presentation on a content platform.

A platform (e.g., a content platform, etc.) can allow a user to access and/or consume (e.g., watch, listen, edit, etc.) a media item (e.g., an audio item, a video item, etc.). For example, a user of a content platform can access a media item on the content platform via a user interface (UI) provided by the content platform to a client device associated with the user. The media item can be provided (e.g., uploaded to the content platform) by the same user or by a different user. In some instances, the user can curate a collection of media items (e.g., a playlist), which can include a grouping of one or more media items for the user or other users' consumption. For example, the user can curate a collection of media items having the same or a similar music genre (e.g., classic rock, jazz, classical, etc.), the same or similar mood (e.g., happy, sad, angry, etc.), the same or similar instrumentation (e.g., strings, percussion, woodwinds, etc.), etc.

The collection of media items can be presented in the UI in connection with a thumbnail image (e.g., a cover art). A thumbnail image can refer to an image, oftentimes serving as a reduced-sized version (e.g., a cropped or scaled-down version) of a larger image or video. On a content platform, a thumbnail image can appear in connection with one or more media items in order to visually appeal to users, grab the users' attention, and/or to convey some meaning or essence of the content represented in the one or more media items to the users. In some instances, a user may wish to generate a new thumbnail image associated with the collection of media items to reflect the user's preferences, such as the user's preferences with respect to the depiction and illustration of artwork depicted in the thumbnail image. For example, the user may want to generate a new thumbnail image to reflect expressive aspects included in the collection of media items, such as genre, mood, emotion, lyrics, rhythm, instrumentation, vocal style, production style, cultural context, theme, etc. In another example, the user may want to customize the thumbnail image to reflect stylistic features, such as an art style, an art pattern, an art medium, a color palette, etc. However, a content platform may lack an option for the user to customize a thumbnail image associated with a collection of media items. Instead, a collection of media items may be presented in the UI in connection with a default thumbnail image (e.g., a default cover art). For example, where the collection of media items is a collection of audio items (e.g., songs), the default thumbnail image is typically an arrangement (e.g., a collage) of album cover images from albums to which songs in the collection of media items belong. Thus, the user would have no option to customize or request to customize the thumbnail image associated with the collection of media items. The lack of thumbnail image customization options can significantly limit the user's control when curating a collection of media items. Further, the default thumbnail image may not be an accurate representation of the content in the collection of media items.

Implementations of the present disclosure address the above and other deficiencies by using artificial intelligence (AI) generative models to generate customized thumbnail images for presentation on a content platform, where a thumbnail image associated with a collection of media items may be customized according to metadata characterizing expressive aspects of the collection of media items and/or according to stylistic features that can be selected from a list of stylistic features presented to an individual user. For example, the user can request that a thumbnail image be generated to be used in connection with the presentation of the collection of media items on the content platform. The request can include an identifier of the collection of media items and/or one or more stylistic features. The stylistic features can include an art style, an art pattern, an art medium, a color palette, etc. Additionally, or alternatively, metadata items associated with the collection of media items can be identified, where the metadata items characterize expressive aspects of the collection of media items (e.g., genre, mood, emotion, lyrics, rhythm, instrumentation, vocal style, production style, cultural context, and/or theme, etc.). A textual prompt can be generated based on the metadata items and/or the stylistic features. For example, the textual prompt can be generated based on a template that specifies the parts of the textual prompt, the sequence of the parts in the textual prompt, certain keywords, etc. The textual prompt can be fed as input to an artificial intelligence (AI) generative model that is trained to generate a thumbnail image customized according to metadata items. One or more outputs can be obtained from the AI generative model, where the one or more outputs include one or more customized thumbnail images. The collection of media items can then be presented in a user interface (UI) of the content platform in connection with the one or more customized thumbnail images. Thus, the user is able to request a customized thumbnail image for a collection of media items, enabling the user to have greater control when curating the collection of media items on the content platform and selecting a thumbnail image that better represents the content in the collection of media items.

However, offering users the ability to use customized thumbnail images in association with a particular collection of media items can introduce several security concerns, particularly with respect to the types of content represented in the customized thumbnail images. Such inappropriate content in customized thumbnail images can lead to disruptions on a content platform, including to the user experience on the content platform, to the reputation and trust of the content platform, to compliance and legal obligations of the content platform, etc.

Implementations of the present disclosure address the above and other deficiencies by generating customized thumbnail images that are content-appropriate. For example, as discussed above, a user can request that a thumbnail image be generated to be used in connection with the presentation of the collection of media items on the content platform. The request can include an identifier of the collection of media items and/or one or more stylistic features specified (e.g., inputted) by the user. The stylistic features can include an art style, an art pattern, an art medium, a color palette, etc. Additionally, or alternatively, metadata items associated with the collection of media items can be identified, where the metadata items characterize expressive aspects of the collection of media items (e.g., genre, mood, emotion, lyrics, rhythm, instrumentation, vocal style, production style, cultural context, and/or theme, etc.). A textual prompt can be generated based on the metadata items and/or the stylistic features. For example, the textual prompt can be generated based on a template that specifies the parts of the textual prompt, the sequence of the parts in the textual prompt, certain keywords, etc. The content platform can then determine whether the textual prompt satisfies a content appropriateness condition. For example, one or more terms of the textual prompt can be compared to an allowlist of prompt terms that specify content-appropriate data (e.g., safe and/or trusted content, as specified by the content platform). The prompt can include a set of strings (e.g., words), where each string characterizes an element, an aspect, or an attribute, etc. of the safe and/or trusted content. It can be identified whether the allowlist includes the one or more terms of the textual prompt. For example, the textual prompt can include the following terms: “[This] [is] [a] [textual] [prompt].,” Each term of the textual prompt can be compared to the prompt terms included in the allowlist. If each term of the textual prompt (e.g., each of the strings [This] [is] [a] [textual] [prompt]) is included in the allowlist (e.g., the set of strings included in the prompt terms includes at least the following strings: [This] [is] [a] [textual] [prompt]), the textual prompt satisfies the content appropriateness condition.

In response to determining that the textual prompt satisfies the content appropriateness content, the textual prompt can be fed as input to an artificial intelligence (AI) generative model that is trained to generate one or more customized thumbnail images, as discussed above.

In some implementations, if at least one term of the textual prompt is not included in the allow list (e.g., the set of strings included in the prompt terms does not include each of the following strings: [This] [is] [a] [textual] [prompt]), the textual prompt does not satisfy the content appropriateness condition. In some embodiments, in response to determining that the textual prompt does not satisfy the content appropriateness condition, the term of the textual prompt not included in the allowlist can be discarded (e.g., the term of the textual prompt is not fed as input to the AI generative model). In some embodiments, the entire textual prompt can be discarded (e.g., the textual prompt is not fed as input to the AI generative model). In some embodiments, in response to determining that the textual prompt does not satisfy the content appropriateness condition, the textual prompt can be modified to remove the inappropriate content (e.g., by removing the one or more stylistic features inputted by the user). The modified textual prompt can be fed as input to the AI model, as described above, to obtain one or more new customized thumbnail images.

In some implementations, in response to obtaining the one or more customized thumbnail images from the AI generative model, each of the one or more customized thumbnail images can be provided to another AI model that is trained to identify a probability that a thumbnail image of a set of thumbnail images includes inappropriate content as defined by pertinent laws, regulations, and/or platform rules. One or more outputs can be obtained from the AI model, where the one or more outputs indicates a probability of each of the one or more customized thumbnail images including inappropriate content. In response to determining that the probability of a customized thumbnail image of the one or more customized thumbnail images including inappropriate content satisfies a threshold criterion (e.g., that the probability is greater than or equal to a threshold value), the customized thumbnail image can be discarded. In some embodiments, in response to determining that the probability of a customized thumbnail image of the one or more customized thumbnail images including inappropriate content satisfies the threshold criterion, the textual prompt can be modified to remove the inappropriate content (e.g., by removing the one or more stylistic features inputted by the user). The modified textual prompt can be fed as input to the AI generative model, as described above, to obtain one or more new customized thumbnail images. In some embodiments, in response to determining the probability of a customized thumbnail image of the one or more customized thumbnail images including inappropriate content does not satisfy the threshold criterion (e.g., that the probability is less than the threshold value), the collection of media items can be presented in a user interface (UI) of the content platform in connection with the one or more customized thumbnail images.

Aspects of the present disclosure provide technical advantages over previous solutions. Aspects of the present disclosure can provide an automated tool that uses trained AI models to assist in providing customized thumbnail images that take into account the particular stylistic preferences of a user and/or expressive aspects of a collection of media items. Further, this tool can be integrated into various services, such as content platforms, which can allow users to more effectively curate and/or share collections of media items with other users. The use of trained AI models can also result in more efficient use of processing resources utilized to generate customized thumbnail images by avoiding the consumption of computing resources needed to manually (e.g., using non-automated processes) generate customized thumbnail images, thereby resulting in an increase of overall efficiency of the content platform. Further, aspects of the present disclosure can provide an automated tool that uses trained AI models and allowlists to assist in determining content-appropriate customized thumbnail images for presentation in a user interface of a content platform. The use of trained AI models and allowlists can also result in more efficient use of processing resources utilized to determine content-appropriate customized thumbnail images by avoiding the consumption of computing resources needed to manually (e.g., using non-automated processes) detect and/or mitigate inappropriate content in customized thumbnail images and/or security compromises due to inappropriate content in customized thumbnail images, thereby resulting in an increase of overall efficiency of the content platform. Further, by determining content-appropriate customized thumbnail images, content platforms can protect users by promoting a safer and more positive user experience, which can encourage longer user sessions, higher user interaction rates, etc.

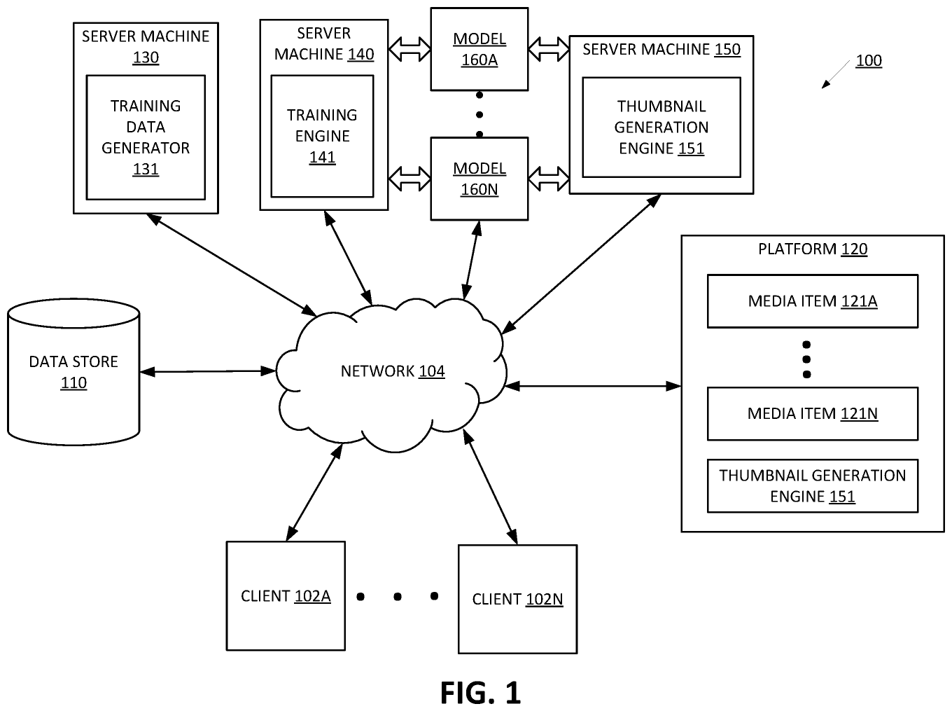

FIG. 1 illustrates an example system architecture 100, in accordance with implementations of the present disclosure. The system architecture 100 (also referred to as “system” herein) includes client devices 102A-N, one or more client devices 104, a data store 110, a platform 120, a server machine 130, a server machine 140, and/or a server 150, each connected to a network 104.

In implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. A data item can include media items, such as audio items and/or video items, in accordance with embodiments described herein. In some embodiments, data store 110 can store one or more allowlists. Each allowlist can include prompt terms that specify content-appropriate data (e.g., safe and/or trusted content, as specified by a content platform). The prompt can include a set of strings (e.g., words), where each string characterizes an element, an aspect, or an attribute, etc. of the safe and/or trusted content. In some embodiments, data store 110 can store one or more denylists. Each denylist can include prompt terms that specify inappropriate content (e.g., unsafe and/or untrusted content, as specified by a content platform).

Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines (e.g., the server 130) coupled to the platform 120 via network 104.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” Client devices 102A-N can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content platform application for users to access content (e.g., media items 121A-121N) on platform 120. As such, the content viewers and/or the UI associated with the content viewer can be provided to client devices 102A-N by platform 120. In one example, the content viewers may be embedded media players that are embedded in web pages provided by the platform 120.

A media item 121A-121N can be consumed via the Internet or via a mobile device application, such as a content viewer of client devices 102A-N. In some embodiments, a media item 121A-121N can correspond to a media file (e.g., a video file, an audio file, a video stream, an audio stream, etc.). In other or similar embodiments, a media item 121A-121N can correspond to a portion of a media file (e.g., a portion or a chunk of a video file, an audio file, etc.). As discussed previously, a media item 121A-121N can be requested for presentation to the user by the user of the platform 120. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121A-121N, or references (e.g., identifiers) to the media items 121A-121N, using the data store 110, in at least one implementation. In another implementation, the platform 120 can store media item 121A-121N or fingerprints as electronic files in one or more formats using data store 110. Platform 120 can provide media item 121A-121N to a user associated with a client device 102A-N by allowing access to media item 121A-121N (e.g., via a content platform application), transmitting the media item 121A-121N to the client device 102A-N, and/or presenting or permitting presentation of the media item 121A-121N via client device 102A-N.

In some embodiments, media item 121A-121N can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional, and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

In some embodiments, system 100 can include one or more third-party platforms (not shown). In some embodiments, a third-party platform can provide other services associated media items 121A-121N. For example, a third-party platform can include an advertisement platform that can provide video and/or audio advertisements. In another example, a third-party platform can be a video streaming service provider that produces a media streaming service via a communication application for users to play videos, TV shows, video clips, audio, audio clips, and movies, on client devices 102A-N via the third-party platform.

In some embodiments, a client device 102A-N can transmit a request to platform 120 for access to a media item 121A-121N. Platform 120 may identify the media item 121A-121N of the request (e.g., at data store 110, etc.) and may provide access to the media item 121A-121N via the UI of the content viewer provided by platform 120. In some embodiments, the requested media item 121A-121N may have been generated by another client device 102A-N connected to platform 120.

As illustrated in FIG. 1, platform 120 can include a thumbnail generation engine 151. Thumbnail generation engine 151 can be configured to generate customized thumbnail images to be used in connection with a collection of media items 121A-121N, where each thumbnail image is customized according to metadata items characterizing expressive aspects of the collection of media items and/or according to stylistic features specified by a user of platform 120.

In some embodiments, thumbnail generation engine 151 can generate customized thumbnail images using one or more artificial intelligence (AI) models 160A-N. For example, platform 120 can receive (e.g., from a client device 102, etc.) a request to generate a thumbnail image to be used in connection with a presentation of a collection of media items 121A-121N that is to be accessible by users of platform 120. In response to receiving the request, the thumbnail generation engine 151 can identify metadata items associated with the collection of media items, where the metadata items characterize expressive aspects of the collection of media items (e.g., genre, mood, emotion, lyrics, rhythm, instrumentation, vocal style, production style, cultural context, and/or theme, etc.). In some embodiments, the thumbnail generation engine 151 can identify one or more stylistic features that can be selected from a list of stylistic features and/or specified (e.g., inputted) by a user. The thumbnail generation engine 151 can generate a textual prompt using the metadata items and/or the one or more stylistic features. For example, the textual prompt can be generated based on a template that specifies the parts of the textual prompt, the sequence of the parts in the textual prompt, certain keywords, etc. The thumbnail generation engine 151 can feed the textual prompt as input to a trained AI model 160. AI model 160 can be trained to predict, for a given textual prompt, a thumbnail image that is customized according to the textual prompt (e.g., according to metadata items characterizing expressive aspects of the collection of media items and/or according to stylistic features specified by the user of platform 120), in accordance with embodiments described herein.

In some embodiments, in response to generating the textual prompt using at least one or more stylistic features that are specified (e.g., inputted) by the user, the thumbnail generation engine 151 can determine whether the textual prompt satisfies a content appropriateness condition. For example, the thumbnail generation engine 151 can compare one or more terms of the textual prompt to an allowlist of prompt terms that specify content-appropriate data (e.g., safe and/or trusted content, as specified by the content platform). The prompt can include a set of strings (e.g., words), where each string characterizes an element, an aspect, or an attribute, etc. of the safe and/or trusted content. The thumbnail generation engine 151 can identify whether the allowlist includes the one or more terms of the textual prompt. For example, the textual prompt can include the following terms: “[This] [is] [a] [textual] [prompt],” where each string (e.g., word) in the textual prompt is an individual term of the textual prompt. The thumbnail generation engine 151 can compare each term of the textual prompt to the prompt terms included in the allowlist. If each term of the textual prompt (e.g., each of the strings [This] [is] [a] [textual] [prompt]) is included in the allowlist (e.g., the set of strings included in the prompt terms includes at least the following strings: [This] [is] [a] [textual] [prompt]), the thumbnail generation engine 151 can determine that the textual prompt satisfies the content appropriateness condition.

In response to determining that the textual prompt satisfies the content appropriateness content, the thumbnail generation engine 151 can feed the textual prompt as input to the AI model 160, as discussed above.

In some implementations, if at least one term of the textual prompt is not included in the allow list (e.g., the set of strings included in the prompt terms does not include each of the following strings: [This] [is] [a] [textual] [prompt]), the thumbnail generation engine 151 can determine that the textual prompt does not satisfy the content appropriateness condition. In some embodiments, in response to determining that the textual prompt does not satisfy the content appropriateness condition, the thumbnail generation engine 151 can discard the term of the textual prompt not included in the allowlist (e.g., the term of the textual prompt is not fed as input to the AI generative model). In some embodiments, the thumbnail generation engine 151 can discard the entire textual prompt (e.g., the textual prompt is not fed as input to the AI model 160). In some embodiments, in response to determining that the textual prompt does not satisfy the content appropriateness condition, the thumbnail generation engine 151 can modify the textual prompt to remove the inappropriate content (e.g., by removing the one or more stylistic features inputted by the user). The thumbnail generation engine 151 can feed the modified textual prompt as input to the AI model, as described above, to obtain one or more new thumbnail images.

In some implementations, in response to obtaining the one or more customized thumbnail images from the AI generative model, the thumbnail generation engine 151 can provide each of the one or more customized thumbnail images to another AI model that is trained to identify a probability that a thumbnail image of a set of thumbnail images includes inappropriate content. The thumbnail generation engine 151 can obtain one or more outputs from the AI model, where the one or more outputs indicates a probability of each of the one or more customized thumbnail images including inappropriate content. In response to determining that the probability of a customized thumbnail image of the one or more customized thumbnail images including inappropriate content satisfies a threshold criterion (e.g., that the probability is greater than or equal to a threshold value), the thumbnail generation engine 151 can discard the customized thumbnail image. In some embodiments, in response to determining that the probability of a customized thumbnail image of the one or more customized thumbnail images including inappropriate content satisfies the threshold criterion, the thumbnail generation engine 151 can modify the textual prompt to remove the inappropriate content (e.g., by removing the one or more stylistic features inputted by the user). The thumbnail generation engine 151 can feed the modified textual prompt as input to the AI model, as described above, to obtain one or more new thumbnail images. In some embodiments, in response to determining the probability of a customized thumbnail image of the one or more customized thumbnail images including inappropriate content does not satisfy the threshold criterion (e.g., that the probability is less than the threshold value), the thumbnail generation engine 151 can cause the collection of media items to be presented in a user interface (UI) of the content platform in connection with the one or more customized thumbnail images.

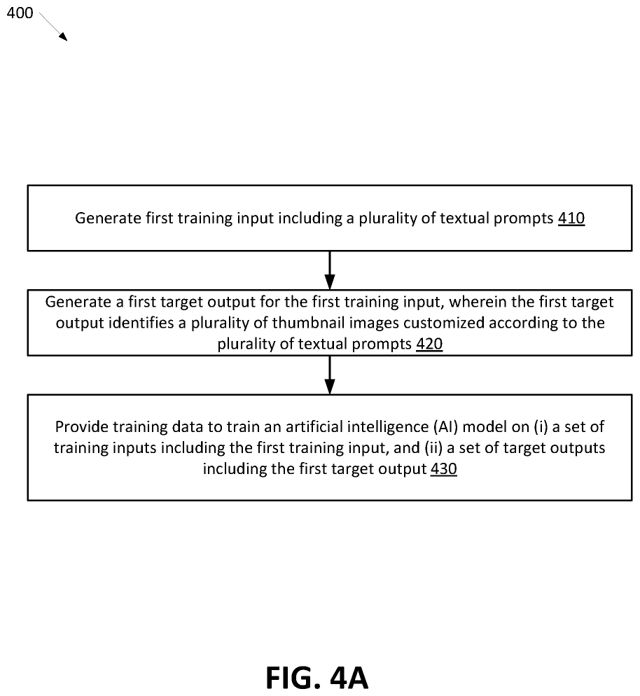

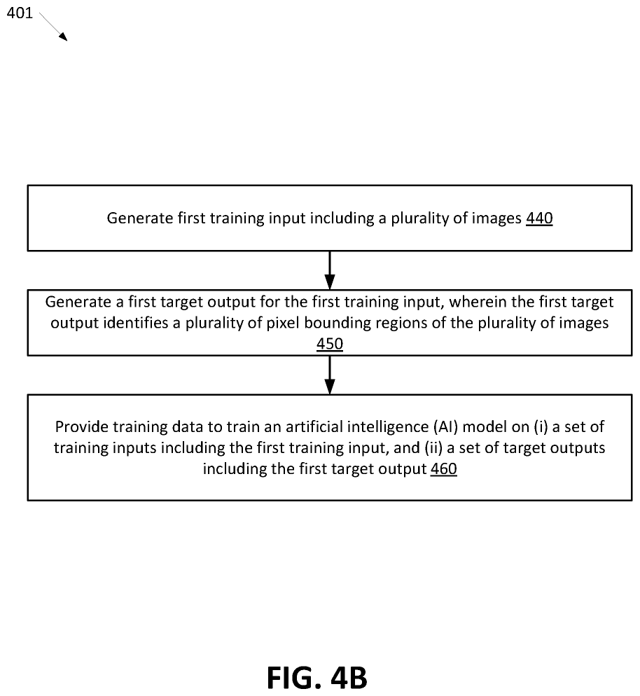

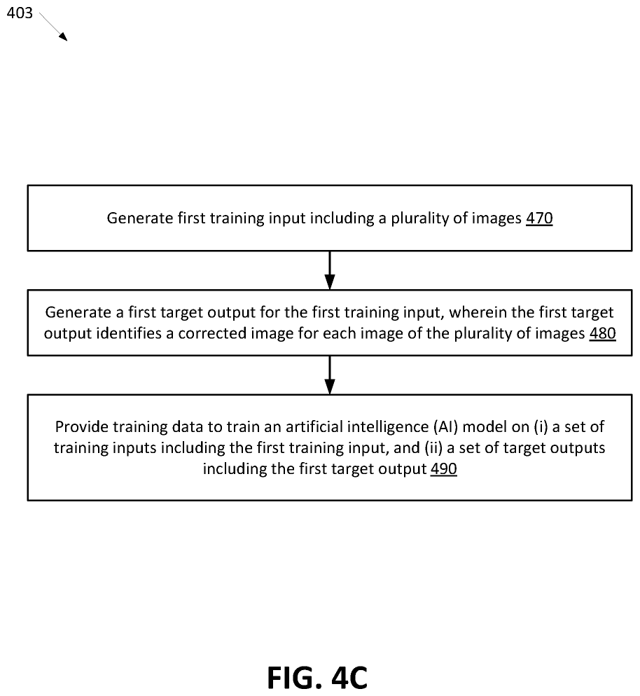

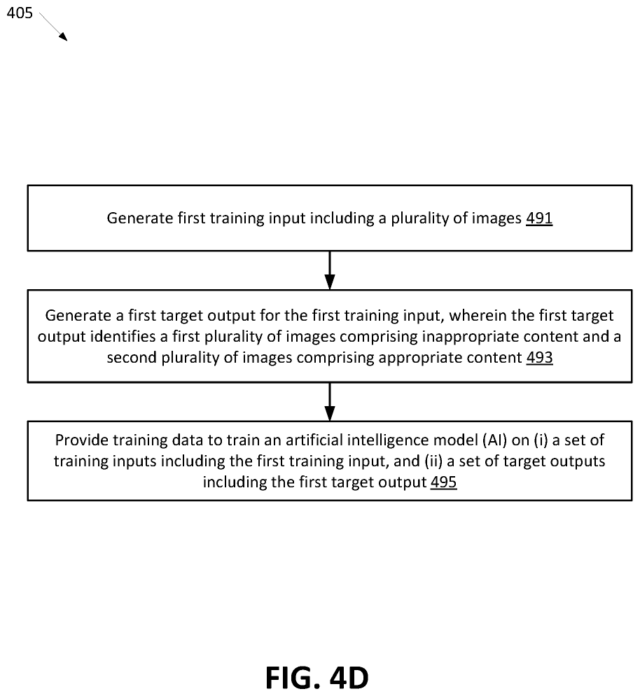

Training data generator 131 (i.e., residing at server machine 130) can generate training data to be used to train AI model 160. In some embodiments, training data generator 131 can generate the training data based on one or more textual prompts (e.g., stored at data store 110 or another data store connected to system 100 via network 104). In an illustrative example, data store 110 can be configured to store a set of training textual prompts. In some embodiments, AI model 160 can be one or more generative, supervised, unsupervised, and/or semi-supervised machine learning models. In such embodiments, training data used to train model 160A-N can include a set of training inputs and a set of target outputs for the training inputs. Further detail with respect to the training of the model 160A-N is described with respect to FIGS. 4A-4D.

Server machine 140 can include a training engine 141. Training engine 141 can train AI model 160A-N using the training data from training data generator 131. In some embodiments, the machine learning model 160A-N can refer to the model artifact that is created by the training engine 141 using the training data that includes training inputs and corresponding target outputs (correct answers for respective training inputs). The training engine 141 can find patterns in the training data that map the training input to the target output (the answer to be predicted), and provide the machine learning model 160A-N that captures these patterns. The machine learning model 160A-N can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model can be trained by, for example, adjusting weights of a neural network in accordance with a backpropagation learning algorithm or the like. In other or similar embodiments, the machine learning model 160A-N can refer to the model artifact that is created by training engine 141 using training data that includes training inputs. Training engine 141 can find patterns in the training data, identify clusters of data that correspond to the identified patterns, and provide the machine learning model 160A-N that captures these patterns. Machine learning model 160A-N can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), etc. Further details regarding generating training data and training machine learning model 160 are provided with respect to FIGS. 4A-4D.

Although FIG. 1 illustrates thumbnail generation engine 151 as part of platform 120, in additional or alternative embodiments, thumbnail generation engine 151 can reside on one or more server machines that are remote from platform 120 (e.g., server machine 150).

In some other implementations, the functions of server machines 130, 140, 150, and/or platform 120 can be provided by a fewer number of machines. For example, in some implementations, components and/or modules of any of server machines 130, 140, 150 may be integrated into a single machine, while in other implementations components and/or modules of any of server machines 130, 140, 150 may be integrated into multiple machines. In addition, in some implementations, components and/or modules of any of server machines 130, 140, 150 may be integrated into platform 120.

In general, functions described in implementations as being performed by platform 120 and/or any of server machines 130, 140, 150 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

In situations in which the systems discussed here collect personal information about users, or may make use of personal information, the users may be provided with an opportunity to control whether platform 120 collects user information (e.g., information about a user's social network, social actions or activities, profession, a user's preferences, or a user's current location), or to control whether and/or how to receive content from the server 130, 140, 150 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the platform 120 and/or server 130, 140, 150.

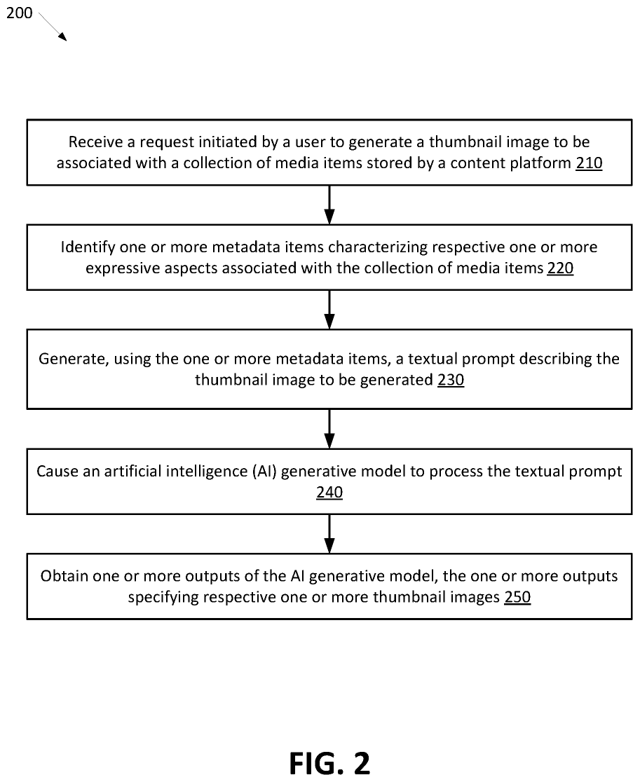

FIG. 2 depicts a flow diagram of a method for generating customized thumbnail images for presentation on a content platform, in accordance with implementations of the present disclosure. Method 200 may be performed by processing logic that may include hardware (circuitry, dedicated logic, etc.), software (e.g., instructions run on a processing device), or a combination thereof. In one implementation, some or all the operations of method 200 may be performed by one or more components of system 100 of FIG. 1 (e.g., platform 120, server(s) 130, 140, 150, and/or thumbnail generation engine 151).

For simplicity of explanation, the method 200 of this disclosure is depicted and described as a series of acts. However, acts in accordance with this disclosure can occur in various orders and/or concurrently, and with other acts not presented and described herein. Furthermore, not all illustrated acts may be required to implement the method 200 in accordance with the disclosed subject matter. In addition, those skilled in the art will understand and appreciate that the method 200 could alternatively be represented as a series of interrelated states via a state diagram or events. Additionally, it should be appreciated that the method 200 disclosed in this specification are capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 210, the processing logic receives a request to generate a thumbnail to be associated with a collection of media items (e.g., media items 121A-121N of FIG. 1) stored by a content platform (e.g., platform 120 of FIG. 1). In some embodiments, the processing logic receives the request from a user of the content platform, where the user is associated with the collection of media items (e.g., the user curated, created, and/or collaborated on the creation of the collection of media items on the content platform). In some embodiments, the request can be received from a client device (e.g., client devices 102A-N of FIG. 1) of the user. In some embodiments, the request can include an identifier of the collection of media items (e.g., identification data used to identify the collection of media items, such as a name assigned to the collection of media items by the user, a different user, the content platform, and/or the client device).

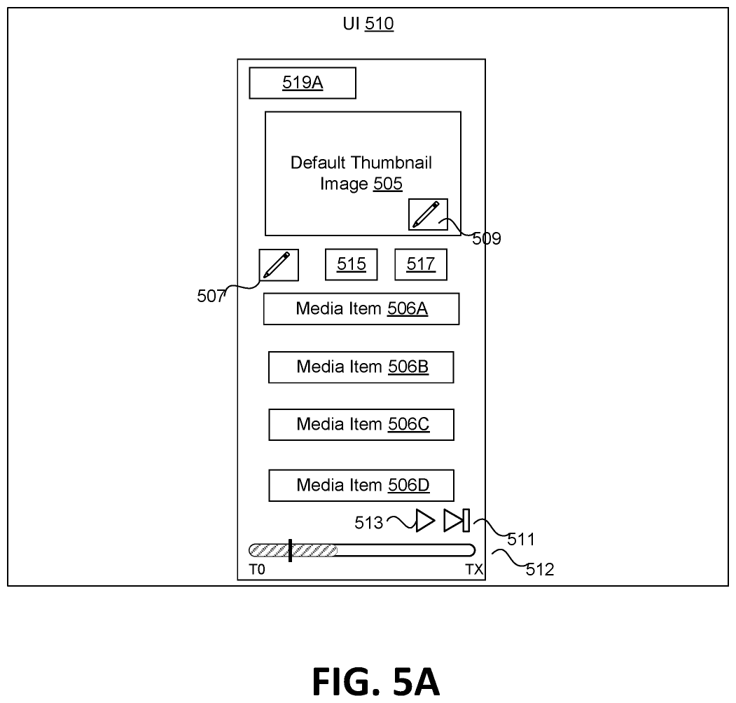

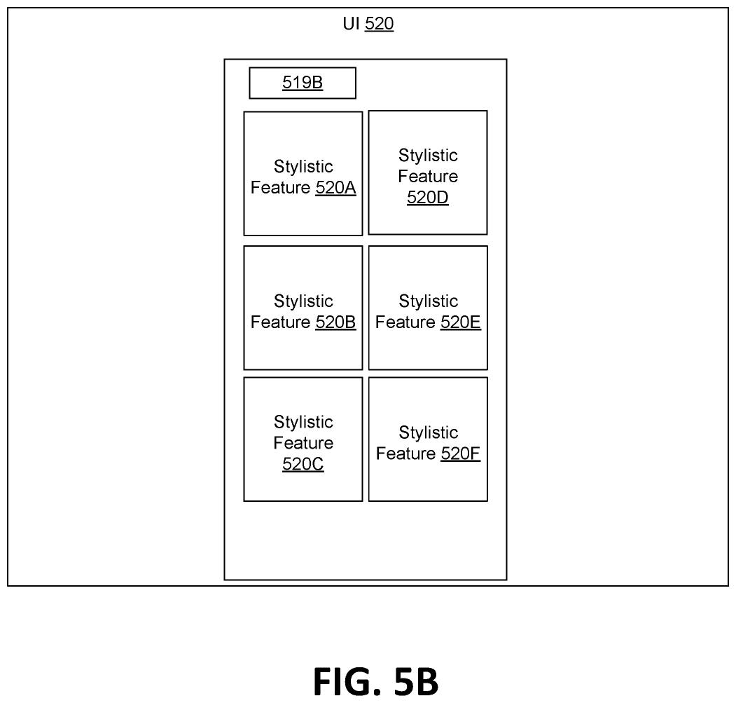

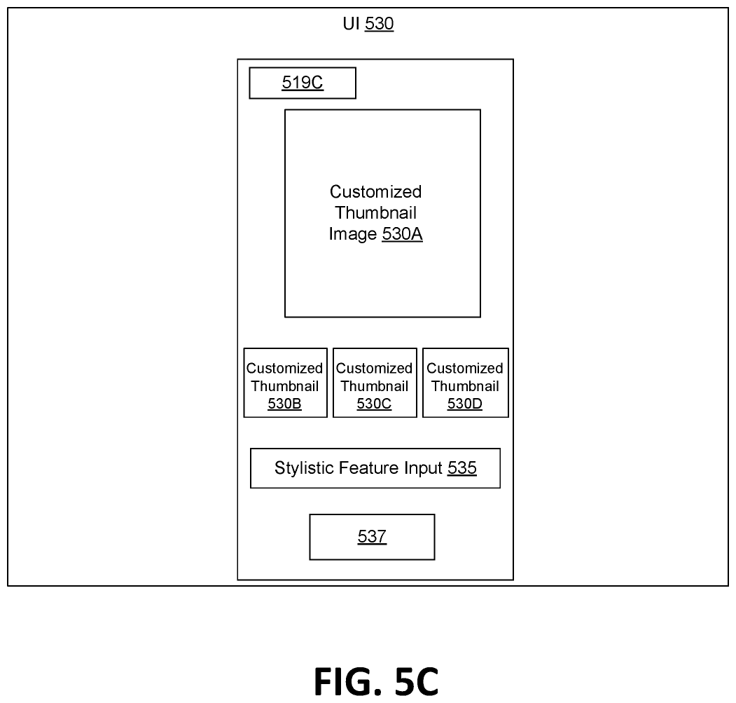

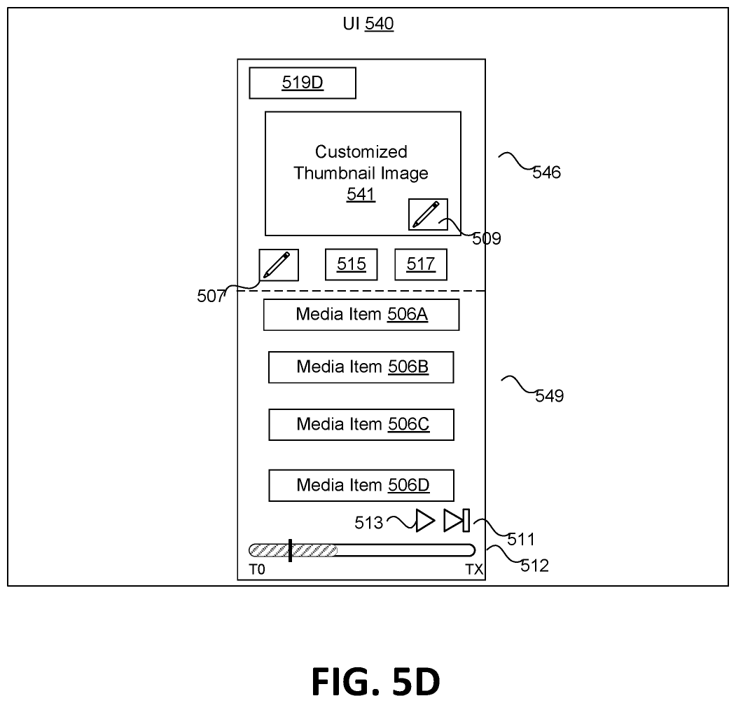

In some embodiments, receiving the request to generate the thumbnail image can include receiving (e.g., detecting) a user interaction event with one or more selectable user interface (UI) elements in one or more UIs presented at the client device. In some embodiments, the one or more UIs can be generated by one or more processing devices of the server 150 of FIG. 1. In some implementations, the platform 120 can provide the UI to enable users to consume and/or access media items on the content platform. Alternatively, the UI can be generated by a platform application hosted by the client device (e.g., client devices 102A-102N). For example, referring to FIGS. 5A-5D, the one or more UIs can include UI 510, UI 520, UI 530, and UI 540. In some embodiments, each UI includes one or more display areas, where each display area can display one or more media items (e.g., media items 506A-506D of FIG. 5A), thumbnail images, and/or selectable UI elements. In some embodiments, the selectable UI elements can include a button, thumbnail, text box, drop-down menu, icon, etc. In some embodiments, the user interaction event can be the user inputting, selecting, clicking on (e.g., by using a mouse, cursor, and/or touchscreen of the client device) the selectable UI elements.

In some embodiments, the user can initiate the request to generate the thumbnail image by interacting with (e.g., selecting and/or clicking on) a button (e.g., button 507 and/or button 509 in FIG. 5A) presented in a UI (e.g., a first UI, such as UI 510 in FIG. 5A). In some embodiments, the UI 510 can include additional UI elements, such as a play button 513, a pause button 511, a timestamp marker 512, additional buttons 515, 517 (e.g., to share the collection of media items with other users, a settings option, etc.), a text description 519A (e.g., a name associated with the collection of media items, such as “Playlist Name”).

At block 220, the processing logic identifies one or more metadata items that is associated with the collection of media items. In some embodiments, the processing logic identifies the one or more metadata items based on the identifier of the collection of media items. For example, the processing logic can retrieve, from a metadata file and/or an entry of a metadata data structure associated with the content platform (e.g., the data store 110 of FIG. 1) the one or more metadata items associated with the identifier of the collection of media items, where each of the one or more metadata items is stored with the identifier of the collection of media items in an entry of the data structure. In some embodiments, the one or more metadata items can characterize one or more expressive aspects associated with the collection of media items. For example, one or more expressive aspects associated with the collection of media items can include one or more of: a genre (e.g., a music genre, such as country, jazz, classical, hip hop, pop, funk, rock, electronic, blues, alternative, disco, metal, ambient, folk, reggae, etc.) associated with the collection of media items, a mood (e.g., sentimental, optimistic, calm, hopeful, reflective, cheerful, excited, gloomy, nostalgic, lonely, etc.) associated with the collection of media items, an emotion (e.g., anger, disgust, fear, joy, calm, love, sadness, excitement, confidence, happiness, etc.) associated with the collection of media items, a lyrics associated with the collection of media items, a rhythm (e.g., accent, meter, tempo, time signature, etc.) associated with the collection of media items, an instrumentation (e.g., percussion, woodwind, strings, piano, etc.) associated with the collection of media items, a vocal style (e.g., pop, jazz, blues, rock, classical, musical theater, vocal jazz, rapping, opera, country, falsetto, etc.) associated with the collection of media items, a production style (e.g., parallel compression, sidechain compression, reverse reverb, gated snare, pitch shifting, autotune, etc.) associated with the collection of media items, a cultural context (e.g., religious, historical, regional, etc.) associated with the collection of media items, and/or a theme (e.g., travel, landscapes, nostalgic, energetic, cute, edgy, textures, food, objects, relax, focus, etc.) associated with the collection of media items.

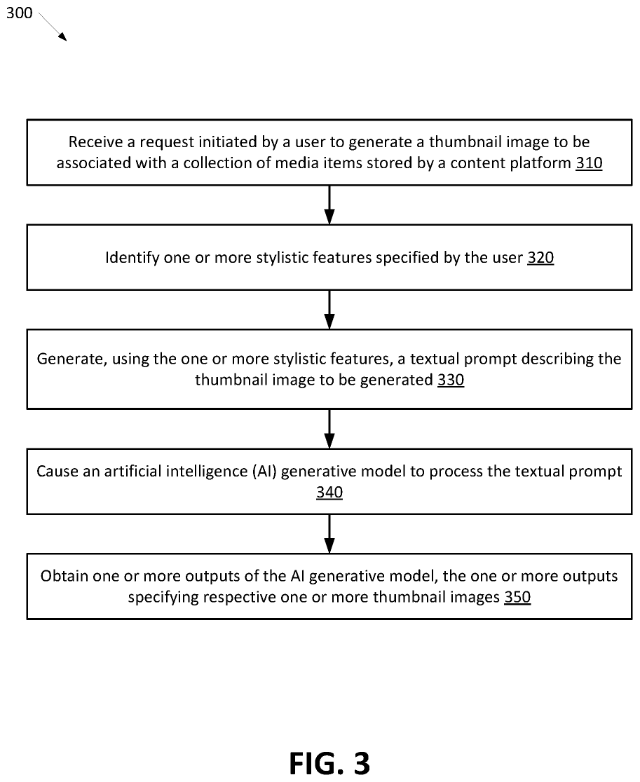

At block 230, the processing logic generates (e.g., constructs) a textual prompt using the one or more metadata items. In some embodiments, the processing logic generates the textual prompt based on the one or more metadata items and/or one or more identified stylistic features specified by the user (e.g., as discussed with respect to FIG. 3). In some embodiments, the textual prompt is generated in order to request a thumbnail customized according to the one or more metadata items and/or the one or more identified stylistic features. The textual prompt can be generated based on a template with blank (e.g., empty) entries (e.g., spaces), where the processing logic can replace the blank entries with the one or more metadata items and each of the one or more identified stylistic features, e.g., by inserting each of the one or more metadata items and each of the one or more identified stylistic features into a blank entry. For example, an example of a textual prompt can be “A depiction of [mood] [genre] music as [stylistic feature 1] art.” Each blank entry can be associated with an identifier of a type of item to insert into the blank entry (e.g., a type of metadata item (e.g., mood, genre, etc.), a stylistic feature (e.g., art style, etc.). In an example, the one or more metadata items identified at block 220 can include a genre of the collection of media items as “rock” and a mood of the collection of media items as “happy.” In an example, the one or more identified stylistic features can include “impressionism.” Thus, using the aforementioned example textual prompt, the processing logic can generate a textual prompt that is “A depiction of happy rock music as impressionism art,” where the processing logic can insert the one or more metadata items and the one or more identified stylistic features into the blank entries of the textual prompt based on the identifier associated with each blank entry. As such, the textual prompt can describe the thumbnail image to the generated, e.g., that the thumbnail image is to be customized to depict happy rock music in the style of impressionism art.

At block 240, the processing logic causes an artificial intelligence (AI) model (e.g., the AI model 160A-N of FIG. 1) to process the textual prompt. For example, causing the AI model to process the textual prompt can include feeding the textual prompt as input to the AI generative model. The AI model can be a tool, program, and/or algorithm that has been trained on a set to data to perform specific tasks using machine learning techniques, predefined rules, statistical algorithms, etc. In some embodiments, the AI model can be a generative AI model and/or a machine learning model that is trained on a set of textual prompts and a set of thumbnail images customized according to the set of textual prompts. For example, in some embodiments, a training engine (e.g., the training engine 141 of FIG. 1) can train, as discussed in detail with respect to FIG. 4A, the machine learning model using training data from a training data generator (e.g., the training data generator 131 of FIG. 1). In some embodiments, the training data can include a set of textual prompts and a set of thumbnail images customized according to the set of textual prompts. In some embodiments, the machine learning model can refer to the model artifact that is created by the training engine using the training data that includes training inputs and corresponding target outputs (correct answers for respective training inputs such as the identifier of a particular user). The training engine can find patterns in the training data that map the training input to the target output (the answer to be predicted), and provide the machine learning model that captures these patterns. The machine learning model can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model can be trained by, for example, adjusting weights of a neural network in accordance with a backpropagation learning algorithm or the like. In other or similar embodiments, the machine learning model can refer to the model artifact that is created by training engine using training data that includes training inputs. Training engine can find patterns in the training data, identify clusters of data that correspond to the identified patterns, and provide the machine learning model that captures these patterns. Machine learning model can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc.

In some embodiments, in response to generating the textual prompt using at least one or more stylistic features inputted by the user (e.g., as discussed with respect to FIG. 3), the processing logic can cause the AI model to process the textual prompt in response to determining that the textual prompt satisfies a content appropriateness condition. For example, the processing logic can compare one or more terms of the textual prompt to an allowlist of prompt terms that includes content-appropriate data (e.g., safe and/or trusted content, as specified by the content platform). The prompt can include a set of strings (e.g., words), where each string characterizes an element, an aspect, or an attribute, etc. of the safe and/or trusted content. The processing logic can identify whether the allowlist includes the one or more terms of the textual prompt. For example, the textual prompt can include the following terms: “A depiction of happy rock music as impressionism art,” where each string (e.g., word) in the textual prompt is an individual term of the textual prompt. The processing logic can compare each term of the textual prompt to the prompt terms included in the allowlist. If each term of the textual prompt (e.g., each of the strings “A depiction of happy rock music as impressionism art”) is included in the prompt terms included in the allowlist (e.g., the set of strings included in the prompt terms includes at least the following strings: “A depiction of happy rock music as impressionism art”), the processing logic can determine that the textual prompt satisfies the content appropriateness condition. In some implementations, if each term of the textual prompt is not included in the prompt terms included in the allowlist (e.g., the set of strings included in the prompt terms does not include at least the following strings: “A depiction of happy rock music as impressionism art”), the processing logic can determine that the textual prompt does not satisfy the content appropriateness condition. In some embodiments, in response to determining that the textual prompt does not satisfy the content appropriateness condition, the processing logic can discard the term of the textual prompt not included in the allowlist. In some embodiments, the processing logic can discard the entire textual prompt. In some embodiments, in response to determining that the textual prompt does not satisfy the content appropriateness condition, the textual prompt can be modified to remove the inappropriate content (e.g., by removing the one or more stylistic features inputted by the user). The modified textual prompt can be fed as input to the AI model, as described above, to obtain one or more new thumbnail images.

At block 250, the processing logic obtains one or more outputs of the AI model. In some embodiments, the one or more outputs include one or more thumbnail images customized according to the one or more metadata items and/or the one or more stylistic features specified by the user. For example, referring to FIG. 5C, the one or more outputs can include the customized thumbnail images 530A-530D.

In some embodiments, in response to obtaining one or more thumbnail images, the processing logic can provide the one or more thumbnail images as input to another AI model (e.g., a second model 160A-N of FIG. 1) that is trained to identify a probability that each of the one or more thumbnail images includes inappropriate content.

The second AI model can be a machine learning model that is trained on a set of images (e.g., a set of thumbnail images). For example, in some embodiments, a training engine (e.g., the training engine 141 of FIG. 1) can train, as discussed in detail with respect to FIG. 4B, the machine learning model using training data from a training data generator (e.g., the training data generator 131 of FIG. 1). In some embodiments, the training data can include a set of images. In some embodiments, the machine learning model can refer to the model artifact that is created by the training engine using the training data that includes training inputs and corresponding target outputs (correct answers for respective training inputs such as the identifier of a particular user). The training engine can find patterns in the training data that map the training input to the target output (the answer to be predicted), and provide the machine learning model that captures these patterns. The machine learning model can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model can be trained by, for example, adjusting weights of a neural network in accordance with a backpropagation learning algorithm or the like. In other or similar embodiments, the machine learning model can refer to the model artifact that is created by training engine using training data that includes training inputs. Training engine can find patterns in the training data, identify clusters of data that correspond to the identified patterns, and provide the machine learning model that captures these patterns. Machine learning model can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc. The processing logic can obtain one or more outputs of the second AI model, where the one or more outputs include a probability of a thumbnail image of the one or more thumbnail images including inappropriate content.

In some embodiments, in response to obtaining the one or more outputs of the second AI model, the processing logic can determine that the probability of the thumbnail image of the one or more thumbnail images including inappropriate content satisfies a threshold criterion (e.g., that the probability is greater than or equal to a threshold value). In some embodiments, the threshold criterion and/or threshold value can be specified by the content platform. In response to determining that the probability of the thumbnail image of the one or more thumbnail images including inappropriate content satisfies the threshold criterion, the processing logic can discard the thumbnail image of the one or more thumbnail images. In some embodiments, in response to determining that the probability of the thumbnail image of the one or more customized thumbnail images including inappropriate content satisfies the threshold criterion, the processing logic can modify the textual prompt to remove the inappropriate content (e.g., by removing the one or more stylistic features inputted by the user). The processing logic can feed the modified textual prompt as input to the AI generative model, as described above, to obtain one or more new thumbnail images.

In some embodiments, in response to determining that the probability of the thumbnail image of the one or more thumbnail images including inappropriate content does not satisfy the threshold criterion (e.g., that the probability is less than the threshold value), the processing logic can cause the collection of media items to be presented with the one or more thumbnail images on the content platform, as discussed below.

In some embodiments, the processing logic can provide the one or more thumbnail images as input to another AI model (e.g., a third model 160A-N of FIG. 1) that is trained to identify one or more pixel bounding regions of each of the one or more thumbnail images, where each pixel bounding region is associated with one or more artifacts in a thumbnail image of the one or more thumbnail images. In some embodiments, the processing logic can provide the one or more thumbnail images as input to the third AI model in response to determining that the probability of the thumbnail image of the one or more thumbnail images including inappropriate content does not satisfy the threshold criterion, as discussed above. In some embodiments, the one or more artifacts can include any unintended and/or unwanted distortions, anomalies, blurring, noise, scratches, blemishes, imperfections, etc. that appear in each of the one or more thumbnail images. The pixel bounding region of each of the one or more thumbnail images can refer to a rectangular area that encloses all the pixels that make up the one or more artifacts in each of the one or more thumbnail images.

The third AI model can be a generative AI model and/or a machine learning model that is trained on a set of images (e.g., a set of thumbnail images) and a set of pixel bounding regions of the set of images. For example, in some embodiments, a training engine (e.g., the training engine 141 of FIG. 1) can train, as discussed in detail with respect to FIG. 4B, the machine learning model using training data from a training data generator (e.g., the training data generator 131 of FIG. 1). In some embodiments, the training data can include a set of images and a set of pixel bounding regions of the set of images. In some embodiments, the machine learning model can refer to the model artifact that is created by the training engine using the training data that includes training inputs and corresponding target outputs (correct answers for respective training inputs such as the identifier of a particular user). The training engine can find patterns in the training data that map the training input to the target output (the answer to be predicted), and provide the machine learning model that captures these patterns. The machine learning model can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model can be trained by, for example, adjusting weights of a neural network in accordance with a backpropagation learning algorithm or the like. In other or similar embodiments, the machine learning model can refer to the model artifact that is created by training engine using training data that includes training inputs. Training engine can find patterns in the training data, identify clusters of data that correspond to the identified patterns, and provide the machine learning model that captures these patterns. Machine learning model can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc.

The processing logic can obtain one or more outputs of the third AI model, where the one or more outputs include a pixel bounding region of each of the one or more thumbnail images that is associated with one or more artifacts in each of the one or more thumbnail images.

In some embodiments, in response to obtaining the one or more outputs of the third AI model, the processing logic can provide one or more thumbnail images and the pixel bounding region of each of the one or more thumbnail images as inputs to another (e.g., a fourth) AI model (e.g., a fourth model 160A-N of FIG. 1) that is trained to perform a correction to the pixel bounding region, where performing the correction includes removing the one or more artifacts from the pixel bounding region of each of the one or more thumbnail images.

The fourth AI model can be a generative AI model and/or a machine learning model that is trained on another (e.g., a second) set of images (e.g., a second set of thumbnail images) and a corrected set of images for the set of images. For example, in some embodiments, a training engine (e.g., the training engine 141 of FIG. 1) can train, as discussed in detail with respect to FIG. 3C, the machine learning model using training data from a training data generator (e.g., the training data generator 131 of FIG. 1). In some embodiments, the training data can include a set of images and a corrected set of images for the set of images. In some embodiments, the machine learning model can refer to the model artifact that is created by the training engine using the training data that includes training inputs and corresponding target outputs (correct answers for respective training inputs such as the identifier of a particular user). The training engine can find patterns in the training data that map the training input to the target output (the answer to be predicted), and provide the machine learning model that captures these patterns. The machine learning model can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model can be trained by, for example, adjusting weights of a neural network in accordance with a backpropagation learning algorithm or the like. In other or similar embodiments, the machine learning model can refer to the model artifact that is created by training engine using training data that includes training inputs. Training engine can find patterns in the training data, identify clusters of data that correspond to the identified patterns, and provide the machine learning model that captures these patterns. Machine learning model can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc.

The processing logic can obtain one or more outputs of the fourth AI model, where the one or more outputs include one or more corrected thumbnail images.

In some implementations, the processing logic can cause the collection of media items to be presented with the one or more thumbnail images (e.g., the corrected one or more thumbnail images, as discussed above) on the content platform. In some embodiments, the processing logic can receive an input (e.g., a selection of a UI element) in the UI that identifies a chosen thumbnail image of the one or more thumbnail images. The processing logic can associate the chosen thumbnail image with the collection of media items. For example, the processing logic can associate, in an entry of a data structure of the content platform (e.g., the data store 110 of FIG. 1), an identifier of the chosen thumbnail image with the identifier of the collection of media items. In some embodiments, in response to associating the chosen thumbnail image with the collection of media items, the processing logic can cause the collection of media items to be presented with the chosen thumbnail image on the content platform. For example, the processing logic can cause the collection of media items to be presented in a first display area of the UI. For example, referring to FIG. 5D, the collection of media items (e.g., the media items 506A-506N) can be caused to be presented in a first display area 549. In some embodiments, the chosen thumbnail image can be caused to be presented in a second display area of the UI. For example, referring to FIG. 5D, the chosen thumbnail image can be caused to be presented in a second display area 546 of the UI. In some embodiments, the second display area can be presented above the first display area of the UI, such that chosen thumbnail image is presented in the UI above the collection of media items. In some embodiments, the UI can include a text description 519D (e.g., a name and/or description of the collection of media items, such as “Playlist Name”).

FIG. 3 depicts a flow diagram of a method for generating customized thumbnail images for presentation on a content platform, in accordance with implementations of the present disclosure. Method 300 may be performed by processing logic that may include hardware (circuitry, dedicated logic, etc.), software (e.g., instructions run on a processing device), or a combination thereof. In one implementation, some or all the operations of method 300 may be performed by one or more components of system 100 of FIG. 1 (e.g., platform 120, server(s) 130, 140, 150, and/or thumbnail generation engine 151).

For simplicity of explanation, the method 300 of this disclosure is depicted and described as a series of acts. However, acts in accordance with this disclosure can occur in various orders and/or concurrently, and with other acts not presented and described herein. Furthermore, not all illustrated acts may be required to implement the method 300 in accordance with the disclosed subject matter. In addition, those skilled in the art will understand and appreciate that the method 300 could alternatively be represented as a series of interrelated states via a state diagram or events. Additionally, it should be appreciated that the method 300 disclosed in this specification are capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 310, the processing logic receives a request to generate a thumbnail image to be associated with a collection of media items (e.g., media items 121A-121N of FIG. 1) on a content platform (e.g., platform 120 of FIG. 1). In some embodiments, the processing logic receives the request from a user of the content platform, where the user is associated with the collection of media items (e.g., the user curated, created, and/or collaborated on the creation of the collection of media items on the content platform). In some embodiments, the request can be received from a client device (e.g., client devices 102A-N of FIG. 1) of the user. In some embodiments, the request can include an identifier of the collection of media items (e.g., identification data used to identify the collection of media items, such as a name assigned to the collection of media items by the user, a different user, the content platform, and/or the client device).

In some embodiments, receiving the request of the user to generate the thumbnail can include detecting a user interaction event with one or more selectable user interface (UI) elements in one or more UIs presented at the client device. In some embodiments, the one or more UIs can be generated by one or more processing devices of the server 150 of FIG. 1. In some implementations, the platform 120 can provide the UI to enable users to consume and/or access media items on the content platform. Alternatively, the UI can be generated by a platform application hosted by the client device (e.g., client devices 102A-102N). For example, referring to FIGS. 5A-5D, the one or more UIs can include UI 510, UI 520, UI 530, and UI 540. In some embodiments, each UI includes one or more display areas, where each display area can display one or more media items (e.g., media items 506A-506D of FIG. 5A), thumbnail images, and/or selectable UI elements. In some embodiments, the selectable UI elements can include a button, thumbnail, text box, drop-down menu, icon, etc. In some embodiments, the user interaction event can be the user inputting, selecting, clicking on (e.g., by using a mouse, cursor, and/or touchscreen of the client device) the selectable UI elements. For example, the user can request to generate the thumbnail by interacting with (e.g., selecting and/or clicking on) a button (e.g., button 507 and/or button 509 in FIG. 5A) presented in a UI (e.g., a first UI, such as UI 510 in FIG. 5A). In some embodiments, the UI 510 can include additional UI elements, such as a play button 513, a pause button 511, a timestamp marker 512, additional buttons 515, 517 (e.g., to share the collection of media items with other users, a settings option, etc.), a text description 519A (e.g., a name associated with the collection of media items, such as “Playlist Name”).

At block 320, the processing logic identifies one or more stylistic features specified by the user. In some embodiments, the processing logic can identify the one or more stylistic features by causing a list of stylistic features to be presented in the UI and receiving one or more selections in the UI of the one or more stylistic features from the list of stylistic features. For example, the user can interact with a thumbnail (e.g., a default and/or previous thumbnail, such as default thumbnail 505 of FIG. 5A) presented in the first UI, where the thumbnail is associated with the collection of media items (e.g., media items 506A-506N of FIG. 5A). In some embodiments, in response to the user interacting with the thumbnail presented in the first UI, the user can interact with the list of stylistic features (e.g., stylistic features 520A-520F of FIG. 5B) presented in one or more additional UIs (e.g., UI 520 of FIG. 5B). In some embodiments, the UI 520 can include a text description 519B (e.g., a description of a purpose of the UI, such as “Edit Playlist”). In some embodiments, the list of stylistic features can be personalized based on a user profile associated with the user on the content platform (e.g., a user's consumption history, a user's profile picture, etc.). For example, the list of stylistic features can be translated to a natural language (e.g., English, Spanish, Russian, etc.) that is specified by the user profile associated with the user. The user profile can be stored, for example, by the content platform in a data store, such as the data store 110 of FIG. 1. In some embodiments, the processing logic can identify the one or more stylistic features specified by the user by receiving an input (e.g., a text input) by the user, where the input specifies the one or more stylistic features. In some implementations, the list of stylistic features can include an art style, an art pattern, an art medium, a color palette, art direction themes (e.g., travel, landscapes, nostalgic, energetic, cute, edgy, textures, food, objects, relax, focus, etc.), and/or other stylistic features relating to a visual representation of artwork. In some examples, art style can include at least one of: symbolism, expressionism, cubism, impressionism, modern art, art nouveau, surrealism, minimalism, art deco, avant-garde, pop art, baroque, anime landscape, comic book illustration, flat illustration, photography, collage art, futurism, etc. In some examples, art pattern can include at least one of: symmetric, asymmetric, geometric, organic, regular, irregular, etc. In some examples, art medium can include at least one of: watercolor, oil paint, acrylic paint, charcoal, etc. In some examples, a color palette can include at least one of: bold colors, pastel colors, monochromatic, etc. In some embodiments, the processing logic can receive a list refresh command (e.g., a selection of a UI element in the UI 520) to refresh the list of stylistic features. In some embodiments, in response to receiving the list refresh command, the processing logic can present another list of stylistic features that includes one or more different stylistic features than what was previously presented in the first list of stylistic features.

In some embodiments, in response to the user interacting with the list of stylistic features (e.g., selecting the one or more stylistic features of the list of stylistic features), the user can interact with a set of thumbnail images (e.g., customized thumbnail images 530A-530D of FIG. 5C) in one or more additional UIs (e.g., UI 530 of FIG. 5C), where each thumbnail of the set of thumbnail images is customized according to the selected one or more stylistic features. In some embodiments, the UI 530 can include a text description 519C (e.g., a description and/or description of the selected one or more stylistic features, such as “Art Patterns”). In some embodiments, the UI 530 can include a stylistic feature input 535, which can be one or more terms of a set of terms associated with the selected one or more stylistic features. In some embodiments, the set of terms can be representative of the selected one or more stylistic features. For example, if the selected one or more stylistic features is “Art Patterns,” then the set of terms can include symmetric, geometric, asymmetric, etc. In some embodiments, the user can interact with the set of terms (e.g., selecting one or more of the set of terms from a drop-down list). In some embodiments, the selected one or more stylistic features can be associated with a set of negating terms (e.g., faces), where each of the set of negating terms is not to be used in connection with the selected one or more stylistic features when generating the thumbnail image. In some embodiments, the set of negating terms can be invisible in the UI 530. The set of terms and the set of negating terms for each of the one or more stylistic features can be retrieved from a data store associated with the content platform (e.g., the data store 110 of FIG. 1). In some embodiments, the user can interact with a randomize button (e.g., button 537 of FIG. 5C) presented in the one or more additional UIs (e.g., UI 530 of FIG. 5C) to determine (e.g., select) a randomized stylistic feature of the list of stylistic features. In some embodiments, in response to interacting with the randomize button, one or more additional customized thumbnail images can be presented in the UI 530. In some embodiments, the one or more additional customized thumbnail images can replace any customized thumbnail images presented in display areas of the UI 530. In some embodiments, the user can interact with one or more additional selectable UI elements to select a particular font for text displayed in the customized thumbnail and/or for text displayed in a display area of one or more of the UIs.

At block 330, the processing logic generates (e.g., constructs) a textual prompt using the one or more stylistic features specified by the user and/or the one or more identified metadata items (as discussed above with respect to FIG. 2). In some embodiments, the textual prompt describes the thumbnail image to be generated. In some implementations, the textual prompt can be generated based on a template with blank (e.g., empty) entries, where the processing logic can replace the blank entries each of the one or more stylistic features and/or the one or more metadata items, e.g., by inserting each of the one or more stylistic features and/or each of the one or more metadata items into a corresponding blank entry. In some embodiments, the processing logic can further replace the blank entries of the template with one or more of the set of terms and one or more of the set of negating terms associated with each of the one or more stylistic features, as discussed above. Each blank entry can be associated with an identifier of a type of item to insert into the blank entry (e.g., a type of metadata item (e.g., mood, genre, etc.), a stylistic feature (e.g., art style, a type of term of the set of terms, a type of negating term of the set of negating terms, etc.). In an example, the one or more metadata items identified at block 220 can include a genre of the collection of media items as “rock” and a mood of the collection of media items as “happy.” In an example, the one or more identified stylistic features can include “impressionism.” Thus, using the aforementioned example textual prompt, the processing logic can generate a textual prompt that is “A depiction of happy rock music as impressionism art,” where the processing logic can insert the one or more metadata items and the one or more identified stylistic features into the blank entries of the textual prompt based on the identifier associated with each blank entry. As such, the text prompt can describe the thumbnail image to be generated, e.g., that the user is requesting a thumbnail image that is customized to depict happy rock music in the style of impressionism art.

At block 340, the processing logic causes an artificial intelligence (AI) model (e.g., the model 160A-N of FIG. 1) to process the textual prompt generated at block 330. In some embodiments, in response to generating the textual prompt using at least one or more stylistic features inputted by the user, the processing logic can cause the AI model to process the textual prompt in response to determining that the textual prompt satisfies the content appropriateness condition, as discussed above. In some embodiments, causing the AI model to process the textual prompt can include the processing logic feeding the textual prompt as input to the AI model. The AI model can be a tool, program, and/or algorithm that has been trained on a set to data to perform specific tasks using machine learning techniques, predefined rules, statistical algorithms, etc. In some embodiments, the AI model can be a generative AI model and/or a machine learning model that is trained on a set of textual prompts and a set of thumbnail images customized according to the set of textual prompts. For example, in some embodiments, a training engine (e.g., the training engine 141 of FIG. 1) can train, as discussed in detail with respect to FIG. 3A, the machine learning model using training data from a training data generator (e.g., the training data generator 131 of FIG. 1). In some embodiments, the training data can include a set of textual prompts and a set of thumbnail images customized according to the set of textual prompts. In some embodiments, the machine learning model can refer to the model artifact that is created by the training engine using the training data that includes training inputs and corresponding target outputs (correct answers for respective training inputs such as the identifier of a particular user). The training engine can find patterns in the training data that map the training input to the target output (the answer to be predicted), and provide the machine learning model that captures these patterns. The machine learning model can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model can be trained by, for example, adjusting weights of a neural network in accordance with a backpropagation learning algorithm or the like. In other or similar embodiments, the machine learning model can refer to the model artifact that is created by training engine using training data that includes training inputs. Training engine can find patterns in the training data, identify clusters of data that correspond to the identified patterns, and provide the machine learning model that captures these patterns. Machine learning model can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc.

In some embodiments, the processing logic causes the AI model to process the textual prompt in response to determining that the textual prompt satisfies a content appropriateness condition. For example, the processing logic can compare one or more terms of the textual prompt to an allowlist of prompt terms that includes content-appropriate data (e.g., safe and/or trusted content, as specified by the content platform). The prompt can include a set of strings (e.g., words), where each string characterizes an element, an aspect, or an attribute, etc. of the safe and/or trusted content. The processing logic can identify whether the allowlist includes the one or more terms of the textual prompt. For example, the textual prompt can include the following terms: “A depiction of happy rock music as impressionism art,” where each string (e.g., word) in the textual prompt is an individual term of the textual prompt. The processing logic can compare each term of the textual prompt to the prompt terms included in the allowlist. If each term of the textual prompt (e.g., each of the strings “A depiction of happy rock music as impressionism art”) is included in the prompt terms included in the allowlist (e.g., the set of strings included in the prompt terms includes at least the following strings: “A depiction of happy rock music as impressionism art”), the processing logic can determine that the textual prompt satisfies the content appropriateness condition. In some implementations, if each term of the textual prompt is not included in the prompt terms included in the allowlist (e.g., the set of strings included in the prompt terms does not include at least the following strings: “A depiction of happy rock music as impressionism art”), the processing logic can determine that the textual prompt does not satisfy the content appropriateness condition. In some embodiments, in response to determining that the textual prompt does not satisfy the content appropriateness condition, the processing logic can discard the term of the textual prompt not included in the allowlist. In some embodiments, the processing logic can discard the entire textual prompt. In some embodiments, in response to determining that the textual prompt does not satisfy the content appropriateness condition, the textual prompt can be modified to remove the inappropriate content (e.g., by removing the one or more stylistic features inputted by the user). The modified textual prompt can be fed as input to the AI model, as described above, to obtain one or more new thumbnail images.

At block 350, the processing logic can obtain one or more outputs of the AI model. In some embodiments, the one or more outputs include one or more thumbnail images. For example, referring to FIG. 5C, the one or more outputs can include the customized thumbnail images 530A-530D.

In some embodiments, in response to obtaining the one or more thumbnail images, the processing logic can provide the one or more thumbnail images as input to another AI model (e.g., a second model 160A-N of FIG. 1) that is trained to identify a probability that each of the one or more thumbnail images includes inappropriate content.

The second AI model can be a machine learning model that is trained on a set of images (e.g., a set of thumbnail images). For example, in some embodiments, a training engine (e.g., the training engine 141 of FIG. 1) can train, as discussed in detail with respect to FIG. 4B, the machine learning model using training data from a training data generator (e.g., the training data generator 131 of FIG. 1). In some embodiments, the training data can include a set of images. In some embodiments, the machine learning model can refer to the model artifact that is created by the training engine using the training data that includes training inputs and corresponding target outputs (correct answers for respective training inputs such as the identifier of a particular user). The training engine can find patterns in the training data that map the training input to the target output (the answer to be predicted), and provide the machine learning model that captures these patterns. The machine learning model can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model can be trained by, for example, adjusting weights of a neural network in accordance with a backpropagation learning algorithm or the like. In other or similar embodiments, the machine learning model can refer to the model artifact that is created by training engine using training data that includes training inputs. Training engine can find patterns in the training data, identify clusters of data that correspond to the identified patterns, and provide the machine learning model that captures these patterns. Machine learning model can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc.

The processing logic can obtain one or more outputs of the second AI model, where the one or more outputs include a probability of a thumbnail image of the one or more thumbnail images including inappropriate content.

In some embodiments, in response to obtaining the one or more outputs of the second AI model, the processing logic can determine that the probability of the thumbnail image of the one or more thumbnail images including inappropriate content satisfies a threshold criterion (e.g., that the probability is greater than or equal to a threshold value). In some embodiments, the threshold criterion and/or threshold value can be specified by the content platform. In response to determining that the probability of the thumbnail image of the one or more thumbnail images including inappropriate content satisfies the threshold criterion, the processing logic can discard the thumbnail image of the one or more thumbnail images. In some embodiments, in response to determining that the probability of the thumbnail image of the one or more thumbnail images including inappropriate content satisfies the threshold criterion, the textual prompt can be modified to remove the inappropriate content (e.g., by removing the one or more stylistic features inputted by the user). The modified textual prompt can be fed as input to the first AI model, as described above, to obtain one or more new thumbnail images.

In some embodiments, in response to determining that the probability of the thumbnail image of the one or more thumbnail images including inappropriate content does not satisfy the threshold criterion (e.g., that the probability is less than the threshold value), the processing logic can cause the collection of media items to be presented with the one or more thumbnail images (e.g., the one or more corrected thumbnail images, as discussed above with respect to FIG. 2) on the content platform. In some embodiments, the processing logic can receive an input (e.g., a selection of a UI element) in the UI that identifies a chosen thumbnail image of the one or more thumbnail images. The processing logic can associate the chosen thumbnail image with the collection of media items. For example, the processing logic can associate, in an entry of a data structure of the content platform (e.g., the data store 110 of FIG. 1), an identifier of the chosen thumbnail image with the identifier of the collection of media items. In some embodiments, in response to associating the chosen thumbnail image with the collection of media items, the processing logic can cause the collection of media items to be presented with the chosen thumbnail image on the content platform. For example, the processing logic can cause the collection of media items to be presented in a first display area of the UI. For example, referring to FIG. 5D, the collection of media items (e.g., the media items 506A-506N) can be caused to be presented in a first display area 549. In some embodiments, the chosen thumbnail image can be caused to be presented in a second display area of the UI. For example, referring to FIG. 5D, the chosen thumbnail image can be caused to be presented in a second display area 546 of the UI. In some embodiments, the second display area can be presented above the first display area of the UI, such that chosen thumbnail image is presented in the UI above the collection of media items. In some embodiments, the UI can include a text description 519D (e.g., a name and/or description of the collection of media items, such as “Playlist Name”).

FIG. 4A depicts a flow diagram of a method for training an artificial intelligence (AI) model, in accordance with implementations of the present disclosure. Method 400 may be performed by processing logic that may include hardware (circuitry, dedicated logic, etc.), software (e.g., instructions run on a processing device), or a combination thereof. In one implementation, some or all the operations of method 400 may be performed by one or more components of system 100 of FIG. 1.

Referring now to FIG. 4A, at block 410, the processing logic generates first training input. In some embodiments, the first training input includes a set of textual prompts. A textual prompt of the set of textual prompts can be generated based on a template with blank (e.g., empty) entries (e.g., spaces). For example, an example of a textual prompt can be in the form of “A depiction of [mood] [genre] music as [stylistic feature 1] art.” For example, a genre of a collection of media items can be “rock” and a mood of the collection of media items can be “happy.” In another example, the stylistic feature can include “impressionism.” Thus, using the aforementioned example textual prompt, the textual prompt can be “A depiction of happy rock music as impressionism art.” As such, the textual prompt can describe a thumbnail image to be generated, e.g., that a user is requesting a thumbnail image that is customized to depict happy rock music in the style of impressionism art.

At block 420, the processing device generates a first target output for the first training input, wherein the first target output identifies a set of thumbnail images customized according to the set of textual prompts.

At block 430, the processing device provides the training data to train an artificial intelligence (AI) model (e.g., the model 160A-N of FIG. 1) on (i) a set of training inputs including the first training input, and (ii) a set of target outputs including the first target output. In some embodiments, each training input of the set of training inputs is mapped to a target output in the set of target outputs.

FIG. 4B depicts a flow diagram of a method for training another artificial intelligence (AI) model, in accordance with implementations of the present disclosure. Method 401 may be performed by processing logic that may include hardware (circuitry, dedicated logic, etc.), software (e.g., instructions run on a processing device), or a combination thereof. In one implementation, some or all the operations of method 401 may be performed by one or more components of system 100 of FIG. 1.

Referring now to FIG. 4B, at block 440, the processing logic generates first training input. In some embodiments, the first training input includes a set of images (e.g., a set of thumbnail images). In some embodiments, the set of images can include a set of distortions, as described herein. At block 450, the processing device generates a first target output for the first training input, wherein the first target output identifies a set of pixel bounding regions of the set of images, where each pixel bounding region is associated with one or more artifacts in each image.

At block 460, the processing device provides the training data to train an artificial intelligence (AI) model (e.g., the model 160A-N of FIG. 1) on (i) a set of training inputs including the first training input, and (ii) a set of target outputs including the first target output. In some embodiments, each training input of the set of training inputs is mapped to a target output in the set of target outputs.

FIG. 4C depicts a flow diagram of a method for training another artificial intelligence (AI) model, in accordance with implementations of the present disclosure. Method 403 may be performed by processing logic that may include hardware (circuitry, dedicated logic, etc.), software (e.g., instructions run on a processing device), or a combination thereof. In one implementation, some or all the operations of method 403 may be performed by one or more components of system 100 of FIG. 1.

Referring now to FIG. 4C, at block 470, the processing logic generates first training input. In some embodiments, the first training input includes a set of images (e.g., a set of thumbnail images) that each include an identified set of pixel bounding regions associated with one or more artifacts in each image.

At block 380, the processing device generates a first target output for the first training input, wherein the first target output identifies a corrected image for each image of the set of images, where the corrected image does not include the one or more artifacts previously present in each image.

At block 490, the processing device provides the training data to train an artificial intelligence (AI) model (e.g., the model 160A-N of FIG. 1) on (i) a set of training inputs including the first training input, and (ii) a set of target outputs including the first target output. In some embodiments, each training input of the set of training inputs is mapped to a target output in the set of target outputs.

FIG. 4D depicts a flow diagram of a method for training another artificial intelligence (AI) model, in accordance with implementations of the present disclosure. Method 405 may be performed by processing logic that may include hardware (circuitry, dedicated logic, etc.), software (e.g., instructions run on a processing device), or a combination thereof. In one implementation, some or all the operations of method 405 may be performed by one or more components of system 100 of FIG. 1.

Referring now to FIG. 4D, at block 491, the processing logic generates first training input. In some embodiments, the first training input includes a set of images (e.g., thumbnail images). At block 493, the processing device generates a first target output for the first training input, wherein the first target output identifies a first subset of images including inappropriate content and a second subset of images including appropriate content.

At block 495, the processing device provides the training data to train an artificial intelligence (AI) model (e.g., the model 160A-N of FIG. 1) on (i) a set of training inputs including the first training input, and (ii) a set of target outputs including the first target output. In some embodiments, each training input of the set of training inputs is mapped to a target output in the set of target outputs.

FIG. 5A is a block diagram illustrating an example user interface (UI) displaying an example collection of media items and a default thumbnail, in accordance with implementations of the present disclosure. FIG. 5A is described with respect to FIGS. 2-3 herein above.

FIG. 5B is a block diagram illustrating another example user interface (UI) displaying one or more UI elements selectable to request a customized thumbnail, in accordance with implementations of the present disclosure. FIG. 5B is described with respect to FIGS. 2-3 herein above.

FIG. 5C is a block diagram illustrating another example user interface (UI) displaying one or more UI elements selectable to request a customized thumbnail, in accordance with implementations of the present disclosure. FIG. 5C is described with respect to FIGS. 2-3 herein above.

FIG. 5D is a block diagram illustrating another example user interface (UI) displaying an example collection of media items and a customized thumbnail, in accordance with implementations of the present disclosure. FIG. 5D is described with respect to FIGS. 2-3 herein above.

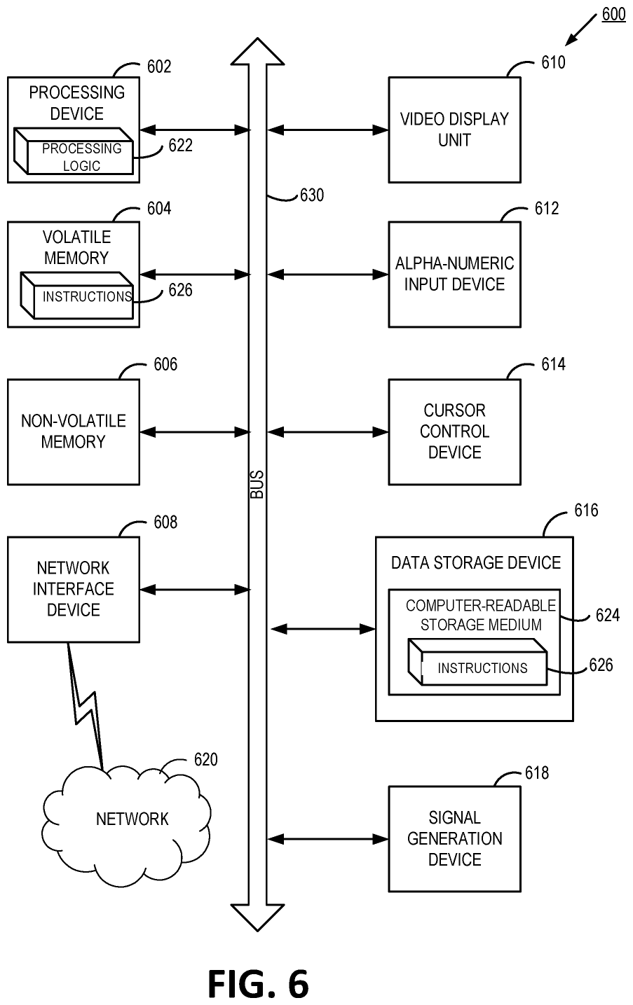

FIG. 6 is a block diagram illustrating an exemplary computer system, in accordance with implementations of the present disclosure. The computer system 600 can be the server 130, 133, and/or 150 or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 618, which communicate with each other via a bus 640.

Processor (processing device) 602 represents one or more general-purpose processing devices such as a microprocessor, central processing unit, or the like. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute instructions 605 (e.g., for generating customized thumbnail images for presentation on a content platform) for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 620 (e.g., a speaker).

The data storage device 618 can include a non-transitory machine-readable storage medium 624 (also computer-readable storage medium) on which is stored one or more sets of instructions 605 (e.g., for generating customized thumbnail images for presentation on a content platform) embodying any one or more of the methodologies or functions described herein. The instructions can also reside, completely or at least partially, within the main memory 604 and/or within the processor 602 during execution thereof by the computer system 600, the main memory 604 and the processor 602 also constituting machine-readable storage media. The instructions can further be transmitted or received over a network 630 via the network interface device 608.

In one implementation, the instructions 605 include instructions for generating customized thumbnail images for presentation on a content platform. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method, comprising:
receiving, by a processing device, a request initiated by a user to generate a thumbnail image to be associated with a collection of media items stored by a content platform;
identifying one or more metadata items characterizing respective one or more expressive aspects associated with the collection of media items;
generating, using the one or more metadata items, a textual prompt describing the thumbnail image to be generated;
causing an artificial intelligence (AI) generative model to process the textual prompt; and
obtaining one or more outputs from the AI generative model, the one or more outputs specifying respective one or more thumbnail images.

2. The method of claim 1, wherein the one or more expressive aspects associated with the collection of media items comprise at least one of: a genre associated with the collection of media items, a mood associated with the collection of media items, an emotion associated with the collection of media items, a lyrics associated with the collection of media items, a rhythm associated with the collection of media items, an instrumentation associated with the collection of media items, a vocal style associated with the collection of media items, a production style associated with the collection of media items, a cultural context associated with the collection of media items, or a theme associated with the collection of media items.

3. The method of claim 1, wherein causing the AI generative model to process the textual prompt is performed responsive to determining that the textual prompt satisfies a content appropriateness condition.

4. The method of claim 3, wherein determining whether the textual prompt satisfies the content appropriateness condition further comprises:
comparing the textual prompt to an allowlist of prompt terms.

5. The method of claim 1, further comprising:
receiving, via a user interface (UI), an input identifying a chosen thumbnail image of the one or more thumbnail images; and
associating the chosen thumbnail image with the collection of media items.

6. The method of claim 1, further comprising:
providing each of the one or more thumbnail images as input to a second trained AI model; and
obtaining one or more outputs of the second trained AI model, the one or more outputs of the second AI model indicating a probability of the thumbnail image comprising an inappropriate content.

7. The method of claim 5, further comprising:
causing the collection of media items to be presented in a first display area of the UI; and
causing the chosen thumbnail to be presented in a second display area of the UI, wherein the second display area of the UI is presented above the first display area of the UI.

8. A system comprising:
a memory device; and
a processing device coupled to the memory device, the processing device to perform operations comprising:
receiving, by the processing device, a request initiated by a user to generate a thumbnail image to be associated with a collection of media items stored by a content platform;
identifying one or more stylistic features specified by the user;
generating, using the one or more stylistic features, a textual prompt describing the thumbnail image to be generated;
causing an artificial intelligence (AI) generative model to process the textual prompt; and
obtaining one or more outputs from the AI generative model, the one or more outputs specifying respective one or more thumbnail images.

9. The system of claim 8, wherein the one or more expressive aspects associated with the collection of media items comprise at least one of: a genre associated with the collection of media items, a mood associated with the collection of media items, an emotion associated with the collection of media items, a lyrics associated with the collection of media items, a rhythm associated with the collection of media items, an instrumentation associated with the collection of media items, a vocal style associated with the collection of media items, a production style associated with the collection of media items, a cultural context associated with the collection of media items, or a theme associated with the collection of media items.

10. The system of claim 8, wherein causing the AI generative model to process the textual prompt is performed responsive to determining that the textual prompt satisfies a content appropriateness condition.

11. The system of claim 10, wherein to determine whether the textual prompt satisfies the content appropriateness condition, the processing device is to perform operations further comprising:
comparing the textual prompt to an allowlist of prompt terms.

12. The system of claim 8, wherein the processing device is to perform operations further comprising:
receiving, via a user interface (UI), an input identifying a chosen thumbnail image of the one or more thumbnail images; and
associating the chosen thumbnail image with the collection of media items.

13. The system of claim 8, wherein the processing device is to perform operations further comprising:
providing each of the one or more thumbnail images as input to a second trained AI model; and
obtaining one or more outputs of the second trained AI model, the one or more outputs of the second AI model indicating a probability of the thumbnail image comprising an inappropriate content.

14. The method of claim 12, wherein the processing device is to perform operations further comprising:
causing the collection of media items to be presented in a first display area of the UI; and
causing the chosen thumbnail to be presented in a second display area of the UI, wherein the second display area of the UI is presented above the first display area of the UI.

15. A non-transitory computer readable storage medium comprising instructions for a server that, when executed by a processing device, cause the processing device to perform operations comprising:
receiving, by the processing device, a request initiated by a user to generate a thumbnail image to be associated with a collection of media items stored by a content platform;
identifying one or more metadata items characterizing respective one or more expressive aspects associated with the collection of media items;
generating, using the one or more metadata items, a textual prompt describing the thumbnail image to be generated;
causing an artificial intelligence (AI) generative model to process the textual prompt;
obtaining one or more outputs from the AI generative model, the one or more outputs specifying respective one or more thumbnail images.

16. The non-transitory computer readable storage medium of claim 15, wherein the one or more expressive aspects associated with the collection of media items comprise at least one of: a genre associated with the collection of media items, a mood associated with the collection of media items, an emotion associated with the collection of media items, a lyrics associated with the collection of media items, a rhythm associated with the collection of media items, an instrumentation associated with the collection of media items, a vocal style associated with the collection of media items, a production style associated with the collection of media items, a cultural context associated with the collection of media items, or a theme associated with the collection of media items.

17. The non-transitory computer readable storage medium of claim 15, wherein causing the AI generative model to process the textual prompt is performed responsive to determining that the textual prompt satisfies a content appropriateness condition.

18. The non-transitory computer readable storage medium of claim 17, wherein to determine whether the textual prompt satisfies the content appropriateness condition, the processing device is to perform operations further comprising:
comparing the textual prompt to an allowlist of prompt terms.

19. The non-transitory computer readable storage medium of claim 15, wherein the processing device is to perform operations further comprising:
receiving, via a user interface (UI), an input identifying a chosen thumbnail image of the one or more thumbnail images; and
associating the chosen thumbnail image with the collection of media items.

20. The non-transitory computer readable storage medium of claim 15, wherein the processing device is to perform operations further comprising:
providing each of the one or more thumbnail images as input to a second trained AI model; and
obtaining one or more outputs of the second trained AI model, the one or more outputs of the second AI model indicating a probability of the thumbnail image comprising an inappropriate content.
